(19) United States
(12) Patent Application Publication
(10) Pub. No.: US 2023/0101510 A1
(43) Pub. Date: Mar. 30, 2023

(54) INFORMATION PROCESSING SYSTEM, METHOD FOR PROCESSING INFORMATION, AND NON-TRANSITORY COMPUTER-READABLE RECORDING MEDIUM

(71) Applicant: FRONTEO, Inc., Tokyo (JP)

(72) Inventors: Yuichi Kichikawa, Tokyo (JP); Toru Hisamitsu, Tokyo (JP); Kazumi Hasuko, Tokyo (JP)

(21) Appl. No.: 17/941,450

(22) Filed: Sep. 9, 2022

(30) Foreign Application Priority Data
Sep. 29, 2021 (JP) 2021-160141

(51) Int. Cl. G06Q 10/08; G06Q 10/06

(52) U.S. Cl. CPC G06Q 10/083; G06Q 10/06312; G06Q 10/067

(57) ABSTRACT

An information processing system includes: a supply chain network obtaining unit obtaining a supply chain network in which a plurality of nodes are connected together with a plurality of links, the plurality of nodes corresponding to a plurality of companies and provided with attributes, the attributes including industrial classifications of the companies and related to the companies, and the plurality of links representing trading relationships associating a company to provide a product and a company to receive the product; and a vector representation calculating unit calculating a plurality of vector representations each corresponding to one of the plurality of nodes, and each representing a feature amount of one of the plurality of nodes, by application of a graph embedding technique to the supply chain network.

### CROSS-REFERENCE TO RELATED APPLICATION

The present application claims priority from Japanese Application JP2021-160141 filed on Sep. 29, 2021, the content to which is hereby incorporated by reference into this application.

### BACKGROUND OF THE INVENTION

### 1. Field of the Invention

The present invention relates to an information processing system, a method for processing information, and a non-transitory computer-readable recording medium.

### 2. Description of the Related Art

Conventionally, various chain analysis and related techniques have been known. A supply chain refers to a series of activities from the procurement of raw materials and components of a product to the manufacture, inventory management, delivery, sale, and consumption of the product. For example, “Analysis of weighted networks” by Newman, Mark E J, Physical review E 70.5 (2004): 056131 discloses a technique to utilize community classification as a technique to extract closely associated companies in the supply chain. Moreover, for example, “Betweenness centrality measures for directed graphs” by White, Douglas R. and Stephen P. Borgatti, Social networks 16.4 (1994): 335-346 discloses a technique to utilize a betweenness centrality index as an evaluation index for evaluating a chokepoint characteristic of a company in the supply chain. Furthermore, “Structure of global buyer-supplier networks and its implications for conflict minerals regulations” by Takayuki Mizuno, Takaaki Ohnishi, and Tsutomu Watanabe, EPJ Data Science 5, Article number 2 (2016) discloses a technique of supply chain analysis, utilizing community classification.

### SUMMARY OF THE INVENTION

The technique of community classification disclosed in “Analysis of weighted networks” by Newman, Mark E J, Physical review E 70.5 (2004): 056131 extracts closely associated companies, using a binary index indicating whether a plurality of companies in a supply chain belong to the same community. However, in the community classification, the companies are classified with this binary index, and it is difficult to evaluate with high accuracy the association of companies on an edge of the community. Moreover, the community classification cannot utilize, for the classification, an element (e.g. domain knowledge) not included in a graph structure indicating a supply chain network. As to the technique to utilize the betweenness centrality index disclosed in “Betweenness centrality measures for directed graphs” by White, Douglas R. and Stephen P. Borgatti, Social networks 16.4 (1994): 335-346, a problem is that the technique cannot evaluate a terminal node of the supply chain network because of the characteristics of the betweenness centrality index.

In addition, links indicating the connection between the companies in the supply chain could include a mixture of essential links related to the businesses of the companies, and non-essential links showing no relationship with the businesses. However, the conventional analysis techniques cannot distinguish between the essential links and the non-essential links. Hence, a problem of the conventional analysis techniques is that these techniques handle the essential links and the non-essential links equally, and cannot appropriately reflect the reality of the supply chain among the companies.

Aspects of the present disclosure are intended to provide an information processing system, a method for processing information, and a non-transitory computer-readable recording medium capable of executing supply chain analysis that reflects reality more closely.

An aspect of the present disclosure relates to an information processing system including: a supply chain network obtaining unit configured to obtain a supply chain network in which a plurality of nodes are connected together with a plurality of links, the plurality of nodes corresponding to a plurality of companies and provided with attributes, the attributes including industrial classifications of the companies and related to the companies, and the plurality of links representing trading relationships associating a company to provide a product and a company to receive the product; and a vector representation calculating unit configured to calculate a plurality of vector representations each corresponding to one of the plurality of nodes, and each representing a feature amount of one of the plurality of nodes, by application of a graph embedding technique to the supply chain network.

Another aspect of the present disclosure relates to an information processing system including: a supply chain network obtaining unit configured to obtain a supply chain network in which a plurality of nodes are connected together with a plurality of links, the plurality of nodes corresponding to a plurality of companies and provided with attributes, the attributes including industrial classifications of the companies and related to the companies, and the plurality of links representing trading relationships associating a company to provide a product and a company to receive the product; a network converting unit configured to convert the supply chain network into a link network, the plurality of links being a plurality of new nodes, each of the plurality of new nodes being provided with a new attribute: determined in accordance with relationships between the plurality of nodes and the plurality of links in the supply chain network; and including information on the industrial classifications, and the new nodes being connected together with a new link determined in accordance with relationships between the plurality of nodes and the plurality of links in the supply chain network such that the link network is generated; and a vector representation calculating unit configured to calculate a plurality of vector representations each corresponding to one of the plurality of new nodes, and each representing a feature amount of one of the plurality of new nodes, by application of a graph embedding technique to the supply chain network.

Still another aspect of the present disclosure relates to a method for processing information executed by an information processing system. The method for the processing includes: obtaining a supply chain network in which a plurality of nodes are connected together with a plurality of links, the plurality of nodes corresponding to a plurality of companies and provided with attributes, the attributes including industrial classifications of the companies and related to the companies, and the plurality of links representing trading relationships associating a company to provide a product and a company to receive the product; and calculating a plurality of vector representations each corresponding to one of the plurality of nodes, and each representing a feature amount of one of the plurality of nodes, by application of a graph embedding technique to the supply chain network.

Still another aspect of the present disclosure relates to a method for processing information executed by an information processing system. The method for the processing includes: obtaining a supply chain network in which a plurality of nodes are connected together with a plurality of links, the plurality of nodes corresponding to a plurality of companies and provided with attributes, the attributes including industrial classifications of the companies and related to the companies, and the plurality of links representing trading relationships associating a company to provide a product and a company to receive the product; converting the supply chain network into a link network, the plurality of links being a plurality of new nodes, each of the plurality of new nodes being provided with a new attribute: determined in accordance with relationships between the plurality of nodes and the plurality of links in the supply chain network; and including information on industrial classifications, and the new nodes being connected together with a new link determined in accordance with relationships between the plurality of nodes and the plurality of links in the supply chain network such that the link network is generated; and calculating a plurality of vector representations each corresponding to one of the plurality of new nodes, and each representing a feature amount of one of the plurality of new nodes, by application of a graph embedding technique to the supply chain network.

Still another aspect of the present disclosure relates to a non-transitory computer-readable recording medium containing a program for causing a processor to implement processing. The processing includes: obtaining a supply chain network in which a plurality of nodes are connected together with a plurality of links, the plurality of nodes corresponding to a plurality of companies and provided with attributes, the attributes including industrial classifications of the companies and related to the companies, and the plurality of links representing trading relationships associating a company to provide a product and a company to receive the product; and calculating a plurality of vector representations each corresponding to one of the plurality of nodes, and each representing a feature amount of one of the plurality of nodes, by application of a graph embedding technique to the supply chain network.

Still another aspect of the present disclosure relates to a non-transitory computer-readable recording medium containing a program for causing a processor to implement processing. The processing includes: obtaining a supply chain network in which a plurality of nodes are connected together with a plurality of links, the plurality of nodes corresponding to a plurality of companies and provided with attributes, the attributes including industrial classifications of the companies and related to the companies, and the plurality of links representing trading relationships associating a company to provide a product and a company to receive the product; converting the supply chain network into a link network, the plurality of links being a plurality of new nodes, each of the plurality of new nodes being provided with a new attribute: determined in accordance with relationships between the plurality of nodes and the plurality of links in the supply chain network; and including information on industrial classifications, and the new nodes being connected together with a new link determined in accordance with relationships between the plurality of nodes and the plurality of links in the supply chain network such that the link network is generated; and calculating a plurality of vector representations each corresponding to one of the plurality of new nodes, and each representing a feature amount of one of the plurality of new nodes, by application of a graph embedding technique to the supply chain network.

### BRIEF DESCRIPTION OF THE DRAWINGS

FIG. 1 is an example of a system structure including an information processing system according to an embodiment;

FIG. 2 is a functional block diagram illustrating an example of a detailed structure of a server system in FIG. 1;

FIG. 3 is a functional block diagram illustrating an example of a detailed structure of a terminal device in FIG. 1;

FIG. 4 is a flowchart schematically showing processing to be executed by the information processing system in FIG. 1;

FIG. 5 is a graph illustrating an example of a supply chain network;

FIG. 6 is a flowchart showing first analysis processing to be executed by the information processing system in FIG. 1;

FIG. 7 is a graph illustrating an example of a supply chain network including virtual nodes;

FIG. 8 is a flowchart showing second analysis processing to be executed by the information processing system in FIG. 1;

FIG. 9 is a graph illustrating an example of a link network;

FIG. 10 is a graph illustrating an example of a link network including virtual nodes;

FIG. 11 is a distribution chart illustrating association degrees between links to enter a node of a given company and links to exit from the node;

FIG. 12 is a graph illustrating an example of a weighted network; and

FIG. 13 shows tables citing an example of results ranking flow amounts for each of the path lengths.

### DETAILED DESCRIPTION OF THE INVENTION

The following descriptions are an embodiment with reference to the drawings. Identical reference signs are used to denote identical or substantially identical constituent elements between the drawings. If the descriptions of such elements are redundant, the redundant descriptions will be omitted as appropriate. Note that the embodiment described below shall not limit the descriptions recited in claims. Moreover, not all of the configurations described in the embodiment are necessarily essential features of the present disclosure. As long as the functions to be described in the present disclosure are carried out, the configurations to be described in the embodiment may be omitted as appropriate.

### 1. Example of System Structure

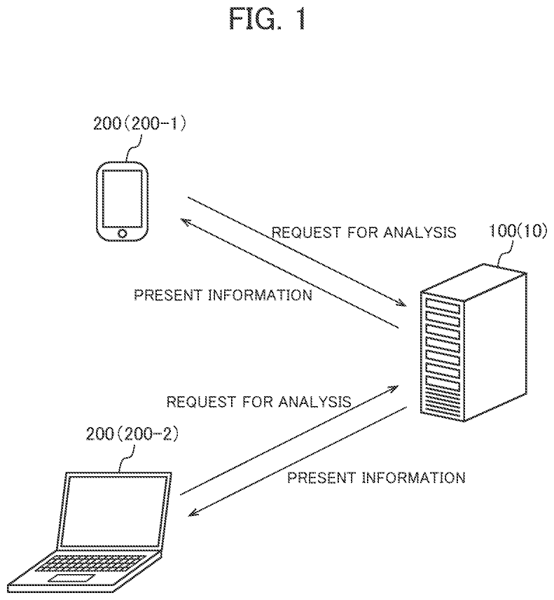

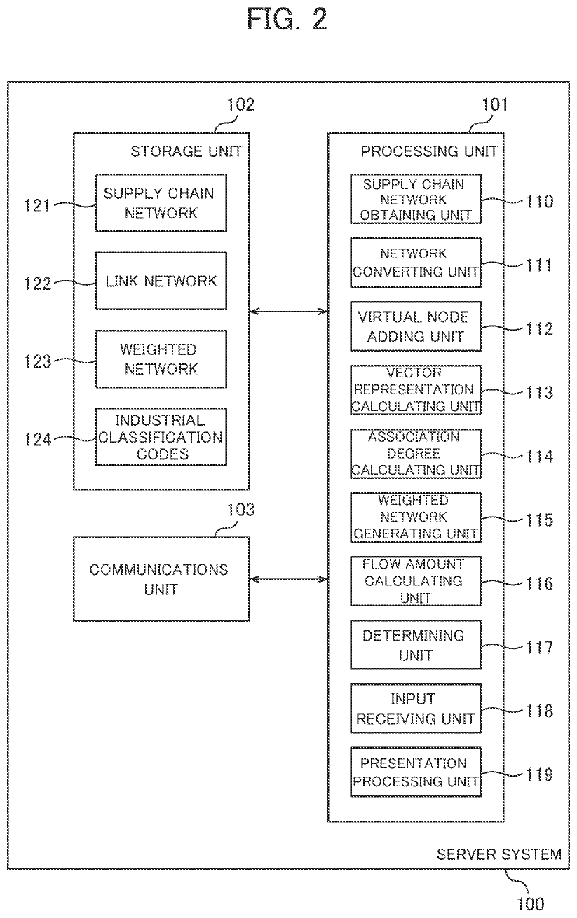

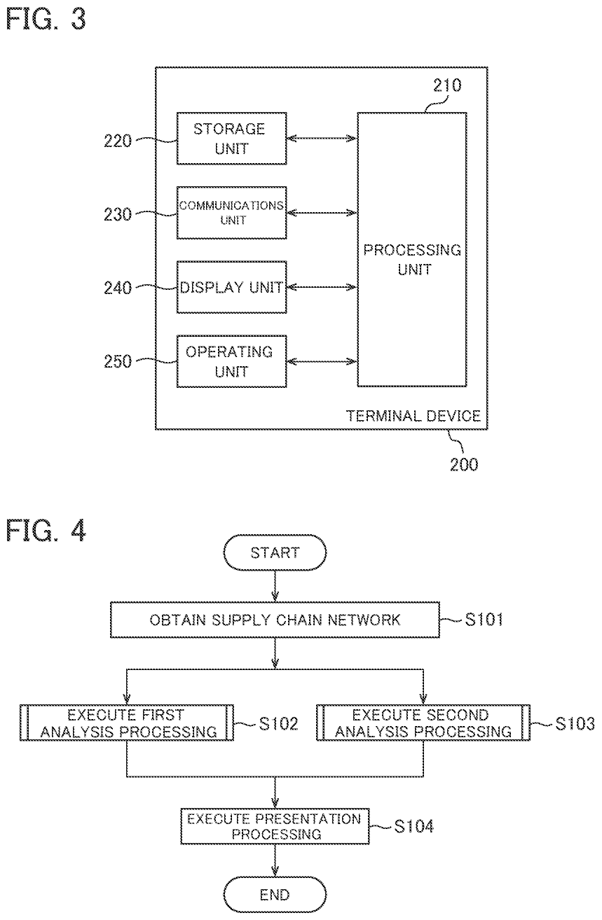

FIG. 1 is an example of a system structure including an information processing system 10 according to an embodiment. The system according to this embodiment includes: a server system 100; and a terminal device 200. Note that the system structure including the information processing system 100 shall not be limited to the system in FIG. 1. The system can be modified in various manners such that, for example, a part of the structure may be omitted, or another constituent element may be additionally included. For example, in FIG. 1, the terminal device 200 includes two terminal devices 200-1 and 200-2. However, the number of the devices 200 shall not be limited to two. Moreover, the same applies to FIGS. 2 and 3 to be shown later, regarding modifications such as omission and addition of constituent elements.

The information processing system 10 of this embodiment corresponds to, for example, the server system 100. Note that the technique in accordance with this embodiment shall not be limited to this example. The processing on the information processing system 10 described in this Specification may be executed by distributed processing, using the server system 100 and another device. For example, the information processing system 10 of this embodiment may be executed by distributed processing on the server system 100 and the terminal device 200. This Specification describes below an example in which the information processing system 10 is the server system 100.

The server system 100 may be either a single server or a plurality of servers. For example, the server system 100 may include a database server and an application server. The database server stores various kinds of data including a supply chain network 121 to be described later. The application server executes processing to be described later with reference to, for example, FIGS. 4, 6, and 8. Note that the plurality of servers here may be physical servers or virtual servers. Moreover, if the virtual servers are used, the virtual servers may be either provided to one physical server, or distributed among a plurality of physical servers. As can be seen, a specific structure of the server system 100 according to this embodiment can be modified in various manners.

The terminal device 200 is used by a user of the information processing system 10. The terminal device 200 may be a personal computer (PC), a mobile terminal device such as a smartphone, or any other like device having a function to be described in this Specification.

The server system 100 is communicably connected to the terminal device 200-1 and the terminal device 200-2, for example, over a network. Hereinafter, the terminal device 200-1 and the terminal device 200-2 will simply be referred to as the terminal device 200 unless the terminal devices have to be distinguished from each other. The network here is, for example, a public communications network such as the Internet. Alternatively, the network may also be a local area network (LAN).

The information processing system 10 of the this embodiment is an open source intelligence (OSINT) system for, for example, collecting and analyzing data related to a target, using, for example, open information. Here, the open information includes various kinds of information widely accessible and legally available. Examples of the open information may include securities reports, inter-industry relations tables, official announcements of the government, news reports on countries and companies, and supply chain databases. Moreover, the open information may include various kinds of information transmitted and received via the social networking service (SNS). For example, the SNS may include services with which users can post, for example, text and images. The open information in this embodiment may include such text and images and results of, for example, natural language processing or image processing of the text and images.

The server system 100 generates nodes including various attributes on the basis of open information. Each node represents a given entity. Here, the entity is a company. Attributes of a node are various kinds of information determined on the basis of open information and including the name, the nationality, the business field, the industrial classification, a trading partner, and trading goods of the company. When a node representing an entity is a company, the node is provided with attributes related to the company, including the industrial classification of the company. Note that the attributes here may include for example, sales, the number of employees, shareholders and their capital contribution ratios, and board members. In this embodiment, among the attributes, at least the industrial classification is provided to a node. The industrial classification classifies kinds of industries into characteristics of the industries. In classifying the industries, for example, industrial classification codes may be used. The industrial classification codes are information to classify the industries into several fields, and a code, such as “01”, is assigned to each of the classification results.

If the attributes of a given node include an attribute including a relationship with another node, the given node and the other node are connected together with a link having a direction. For example, suppose a given company is intended to provide (sell) a trading product of some sort to another company. In this case, a node corresponding to the other company and the node corresponding to the given company are connected together with a link representing a buy-sell relationship (distribution relationship) of the product. Here, the link has a direction from an influencing entity to an influenced entity; that is, for example, from a seller to a buyer of a product of some sort. That is, the link represents a trading relationship that associates a company to provide the product with a company to receive the product.

In accordance with the technique of this embodiment, the server system 100 obtains an entity network; that is, a network in which a plurality of nodes representing a plurality of entities (e.g. companies) are connected together with a plurality of links representing trading relationships. Because the links have directions, the entity network is a directed graph. The server system 100 conducts an analysis based on the entity network, and executes processing to present results of the analysis. For example, the terminal device 200 is a device used by a user of a service provided by an OSINT system. For example, the user uses the terminal device 200 to send a request to the server system 100 for conducting an analysis of some sort. The server system 100 conducts an analysis based on the entity network, and transmits the results of the analysis to the terminal device 200. The entity network in this embodiment is, in a narrow sense of the term, the supply chain network 121 representing a supply chain. Hereinafter, in this embodiment, the entity network is the supply chain network 121.

FIG. 2 is a functional block diagram illustrating an example of a detailed structure of the server system 100. The server system 100 includes, as illustrated in FIG. 2, for example, a processing unit 101, a storage unit 102, and a communications unit 103.

The processing unit 101 of this embodiment includes hardware below. The hardware can include at least one of a digital signal processing circuit or an analogue signal processing circuit. For example, the hardware can include one or a plurality of circuit devices mounted on a circuit board, and one or a plurality of circuit elements. The one or plurality of circuit devices are, for example, an integrated circuit (IC), or a field-programmable gate array (FPGA). The one or plurality of circuit elements are, for example, resistors or capacitors.

The processing unit 101 may be provided in a form of the processor below. The server system 100 of this embodiment includes a memory that stores information, and a processor that operates on the information stored in the memory. The information includes, for example, a program and various kinds of data. The program may include a program to cause the server system 100 to execute the processing described in this Specification. The processor includes hardware. The processor can be various kinds of processors including, for example, a central processing unit (CPU), a graphics processing unit (GPU), and a digital signal processor (DSP). The memory may be: a semiconductor memory such as a static random access memory (SRAM), a dynamic random access memory (DRAM), or a flash memory; a resistor; a magnetic storage device such as a hard disk drive (HDD); or an optical storage device such as an optical disc drive. For example, the memory holds a computer-readable instruction. When the processor executes the instruction, a function of the processing unit 101 is carried out in the form of processing. Here, the instruction may be a set of instructions included in the program, or an instruction for instructing a hardware circuit of the processor to operate.

The processing unit 101 includes, for example, a supply chain network obtaining unit 110, a network converting unit 111, a virtual node adding unit 112, a vector representation calculating unit 113, an association degree calculating unit 114, a weighted network generating unit 115, a flow amount calculating unit 116, a determining unit 117, an input receiving unit 118, and a presentation processing unit 119. In this embodiment, the processing unit 101 executes one of, or both, first analysis processing and second analysis processing. The first analysis processing and the second analysis processing will be described in detail later.

The supply chain network obtaining unit 110 obtains the supply chain network 121. For example, the supply chain network obtaining unit 110 may generate the supply chain network 121 in accordance with open information. The open information includes trading relationship information that associates a company to provide a product with a company to receive the product. The supply chain network obtaining unit 110 stores the generated supply chain network 121 in the storage unit 102. Note that the supply chain network 121 may be generated by a system different from the information processing system 10 according to this embodiment. In such a case, the supply chain network obtaining unit 110 may execute processing to obtain the result of the generated supply chain network 121 from the different system.

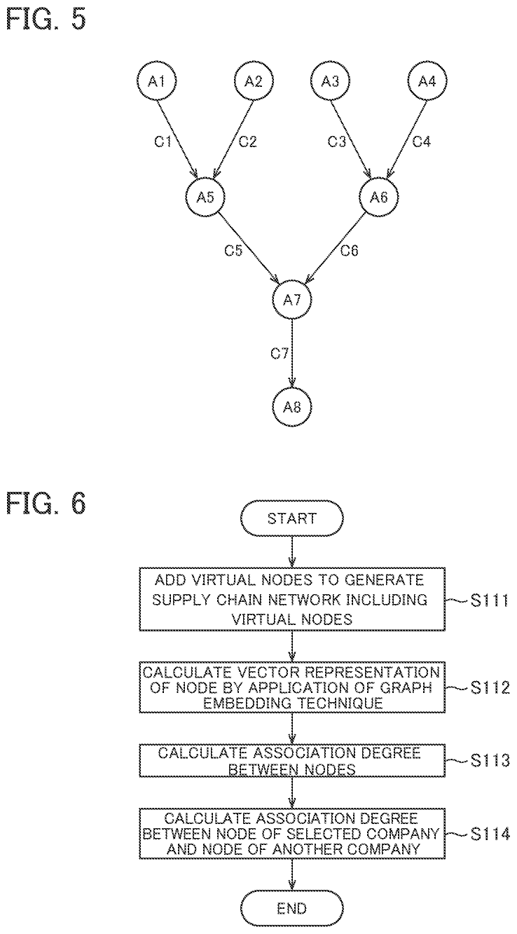

The supply chain network obtaining unit 110, to be described later with reference to, for example, FIG. 5, may obtain, as the supply chain network 121, a network in accordance with the trading relationships of the companies. In the network, a plurality of nodes corresponding to a plurality of companies are connected together.

The network converting unit 111 converts the supply chain network 121 into a link network 122. The link network 122 is a network comprising a plurality of new nodes each of which corresponds to one of a plurality of the links in the supply chain network 121. The new nodes of the link network 122 are provided with new attributes. The new attributes are determined in accordance with the relationships between the plurality of nodes and the plurality of links in the supply chain network 121. The new attributes may include, for example, information on an industrial classification. For example, a given new node included in the link network 122 and representing a given link of the supply chain network 121 is provided with a new attribute of a combination of the industrial classifications provided to the plurality of respective nodes connected together with the given link. That is, in this case, the information on the industrial classification included in the new attribute is the combination of the industrial classifications.

New nodes of the link network 122 are connected together with a new link. The new link is determined in accordance with relationships between the plurality of nodes and the plurality of links in the supply chain network 121. In other words, the new link is determined in accordance with relationships among the links in the supply chain network 121 before conversion. The new link has a direction. Hence, the link network 122 is a directed graph. The link network 122 is used for the second analysis processing. The network converting unit 111 stores the generated link network 122 in the storage unit 102.

The virtual node adding unit 112 adds one or more virtual nodes to either the supply chain network 121 or the link network 122. For example, in the first analysis processing, the virtual node adding unit 112 adds one or more virtual nodes to the supply chain network 121. The one or more virtual nodes represent the industrial classifications of the companies represented by the nodes included in the supply chain network 121. The virtual node adding unit 112 connects together the plurality of nodes and the added virtual nodes with links having directions, in accordance with the industrial classifications included in the attributes each provided to a corresponding one of the plurality of nodes in the supply chain network 121. Specifically, the virtual node adding unit 112 connects a node provided with a given industrial classification and a virtual node representing the given industrial classification together with a link. Hence, the virtual node adding unit 112 generates the supply chain network 121 including the virtual nodes.

For example, in the second analysis processing, the virtual node adding unit 112 adds one or more virtual nodes to be determined in accordance with the industrial classifications of the companies represented by the nodes included in the supply chain network 121. A virtual node added here may represent a combination of the industrial classifications included in attributes each provided to a corresponding one of the nodes connected together in the supply chain network 121. That is, the virtual node may be a node representing a combination of two or more industrial classifications. In accordance with information on the industrial classifications included in the new attributes each provided to a corresponding one of the plurality of new nodes in the link network 122, the virtual node adding unit 112 connects each of the plurality of new nodes and the added virtual node together with links. Specifically, the virtual node adding unit 112 connects a new node provided with a combination of given industrial classifications and a virtual node representing the combination of the given industrial classifications together with a link. Hence, the virtual node adding unit 112 generates the link network 122 including the virtual nodes.

The vector representation calculating unit 113 calculates vector representations by application of a graph embedding technique to the supply chain network 121 or the link network 122.

In the first analysis processing, the vector representation calculating unit 113 calculates a plurality of vector representations each corresponding to one of a plurality of nodes in the supply chain network 121, and each representing a feature amount of one of the plurality of nodes, by application of the graph implanting technique to the supply chain network 121. In the case where the virtual node adding unit 112 generates the supply chain network 121 including virtual nodes, the vector representation calculating unit 113 calculates a plurality of vector representations by application of the graph implanting technique to the supply chain network 121 including the virtual nodes.

In the second analysis processing, the vector representation calculating unit 113 calculates a plurality of vector representations each corresponding to one of a plurality of new nodes in the link network 122, and each representing a feature amount of one of the plurality of new nodes, by application of the graph implanting technique to the link network 122. In the case where the virtual node adding unit 112 generates the link network 121 including virtual nodes, the vector representation calculating unit 113 calculates a plurality of vector representations, by application of the graph embedding technique to the link network 122 including the virtual nodes.

The vector representation calculating unit 113 can use a known graph embedding technique when calculating a vector representation. For example, the vector representation calculating unit 113 can use node2vec as the graph embedding technique. With this technique, the vector representation calculating unit 113 generates a cluster of sequence data formed of links through the use of random walks starting at a given node of the graph structure (the supply chain network 121 or the link network 122 of this embodiment). Then, the vector representation calculating unit 113 applies a technique; namely, skip-gram, to the generated cluster of sequence data, and extracts a feature amount of each node to calculate a vector representation of each node. Note that node2vec is merely an example of the graph embedding technique. The vector representation calculating unit 113 may use another known graph embedding technique to calculate a vector representation.

Using the plurality of vector representations calculated by the vector representation calculating unit 113, the association degree calculating unit 114 calculates an association degree between a plurality of nodes each corresponding to one of the plurality of vector representations. The association degree calculating unit 114 calculates, for example, a cosine similarity as the association degree. The cosine similarity is an index representing a similarity of two nodes in accordance with an angle formed between vector representations of the two nodes. The more similar the two nodes are to each other, the closer the value of the cosine similarity is to 1. The less similar the two nodes are to each other, the closer the value of the cosine similarity is to 0.

In the first analysis processing, the association degree calculating unit 114 calculates association degrees between a plurality of nodes in the supply chain network 121, in accordance with the vector representations. When the input receiving unit 118 to be described later receives a selection operation to select any of the companies represented by the nodes of the supply chain network 121, the association degree calculating unit 114 may calculate an association degree between the node of a company selected by the selection operation and another node.

In the second analysis processing, the association degree calculating unit 114 calculates an association degree between a plurality of new nodes in the link network 122, in accordance with the vector representations.

The weighted network generating unit 115 generates a weighted network 123 in the second analysis processing. The weighted network 123 is a network in which a new link of the link network 122 is provided with a weighting value. The weighting value may be calculated by the weighted network generating unit 115 in accordance with an association degree calculated by the association degree calculating unit 114. That is, the weighted network generating unit 115 calculates a weighting value in accordance with an association degree calculated by the association degree calculating unit 114, and assigns the calculated weighting value to a new link. Hence, the weighted network generating unit 115 generates the weighted network 123. The weighted network generating unit 115 stores the generated weighted network 123 in the storage unit 102. Note that the details of a method for calculating a weighting value executed by the weighted network generating unit 115 will be described later.

The flow amount calculating unit 116 calculates a flow amount in the flow of the weighted network 123, using a weighting value calculated by the weighted network generating unit 115. Here, the flow traces a path of a new link from one given new node to another given new node. The flow amount calculating unit 116 may calculate either the flow amounts of all the flows to be obtained in the weighted network 123, or the flow amount of a flow for a specific new node. Moreover, the flow amount is an index to represent the amount of a trading relationship for a given flow. More specifically, the flow amount represents a value of a trading relationship of a starting node to an ending node in the given flow. The flow amount is calculated in accordance with a weighting value provided to a new link. Details of the method for calculating the flow amount will be described later.

The determining unit 117 determines an important link in the supply chain network 121 or the link network 122, in accordance with a flow amount calculated by the flow amount calculating unit 116. The important link is a link to play an important role in providing a product. Moreover, the determining unit 117 determines a chokepoint characteristic of one or more companies included in the supply chain network 121. A chokepoint is anode originally positioned on a path connecting two communities. If the node disappears, the connection is broken, or the length of the path connecting the nodes significantly increases. The determining unit 117 can calculate an important link or a chokepoint characteristic from the flow amount calculated by the flow amount calculating unit 116. For example, the determining unit 117 can determine an important link or a chokepoint characteristic by executing a predetermined computation on flow amounts calculated by the flow amount calculating unit 116, and comparing the flow amounts or results of the predetermined computation.

Note that the determining unit 117 may determine only one of, or both, the important link and the chokepoint characteristic. Moreover, the determining unit 117 may determine an important node instead of, or together with, the important link. The important node is, for example, a node to be connected with the important link. In this embodiment, the determining unit 117 determines both the important link and the chokepoint characteristic.

The input receiving unit 118 executes processing to receive a selection operation of the user using the information processing system 10. Here, the selection operation includes an operation to select any of a plurality of companies represented by the nodes included in the supply chain network 121. The user performs the selection operation on, for example, an operating unit 250 of the terminal device 200. In such a case, information on the selection operation is transmitted from the terminal device 200 to the server system 100, and the input receiving unit 118 receives the transmitted selection operation. Note that the user may perform the selection operation on a not-shown operating unit included in the server system 100. In such a case, the input receiving unit 118 receives the selection operation on the server system. When the input receiving unit 118 receives an input of the selection operation, for example, the association degree calculating unit 114 calculates, in the first analysis processing, an association degree between a node of a company selected by the selection operation and a node of another company, using a vector representation associated with the node of the company selected by the selection operation and a vector representation associated with the node of the other company.

The presentation processing unit 119 performs presentation processing to present to the user a processing result of the first analysis processing and/or the second analysis processing executed by the processing unit 101. The presentation processing unit 119 executes, for example, processing to display the processing result on a display screen. The display screen is displayed on, for example, a display unit 240 of the terminal device 200. For example, the presentation processing unit 119 executes processing to generate the display screen and transmit the display screen through a communications unit 103 to the terminal device 200. Moreover, the processing shall not be limited to the transmission of the display screen per se. The presentation processing unit 119 may perform processing to transmit information capable of generating the display screen (e.g. a markup language). Note that the display screen may be displayed on an appliance other than the terminal device 200. For example, the display screen may be displayed on a not-shown display unit included in the server system 100. Moreover, the presentation processing executed by the presentation processing unit 119 shall not be limited to the display processing. The presentation processing may include output processing using, for example, audio.

The storage unit 102 is a working area of the processing unit 101, and stores various kinds of information. The storage unit 102 may be provided in the form of various kinds of memories. The memories may include: a semiconductor memory such as an SRAM, a DRAM, a ROM, and a flash memory; a resistor; a magnetic storage device such as a hard disk drive; and an optical storage device such as an optical disc drive.

The storage unit 102 stores, for example, the supply chain network 121 obtained by the supply chain network obtaining unit 110. The storage unit 102 stores, for example, the link network 122 generated by the network converting unit 111. The storage unit 102 stores, for example, the weighted network 123 generated by the weighted network generating unit 115. Moreover, the storage unit 120 may store open information such as securities reports and inter-industry relations tables. Furthermore, the storage unit 120 may store, for example, industrial classification codes 124. The industrial classification codes 124 are, as described above, information to classify the industries into several fields, and a code such as “01” is assigned to each of the classification results. Other than the above information, the storage unit 102 can store various kinds of information for the processing in this embodiment.

The communications unit 103 is an interface for performing communications through a network, and includes, for example, an antenna, a radio frequency (RF) circuit, and a baseband circuit. The communications unit 103 may operate by the control of the processing unit 101, and may include a communications controlling processor different from the processing unit 101. The communications unit 130 is an interface for performing communications in accordance with, for example, the transmission control protocol/Internet protocol (TCP/IP). Note that the specific communications scheme can be modified in various manners.

FIG. 3 is a functional block diagram illustrating an example of a detailed structure of the terminal device 200. The terminal device 200 illustrated in FIG. 3 includes, for example, a processing unit 210, a storage unit 220, a communications unit 230, a display unit 240, and an operating unit 250.

The processing unit 210 is hardware including at least one of a digital signal processing circuit or an analog signal processing circuit. Moreover, the processing unit 210 may be provided in the form of a processor. The processor may include various kinds of processors such as a CPU, a GPU, and a DSP. The processor executes an instruction stored in the memory of the terminal device 200, so that a function of the processing unit 210 is carried out in the form of processing.

The storage unit 220 is a working area of the processing unit 210, and is provided in the form of various kinds of memories such as an SRAM, a DRAM, and a ROM.

The communications unit 230 is an interface for performing communications through a network, and includes, for example, an antenna, an RF circuit, and a baseband circuit. The communications unit 230 performs communications with the server system 100 through, for example, a network.

The display unit 240 is an interface to display various kinds of information, and may be a liquid crystal display, an organic EL display, or a display that operates under any other scheme. The operating unit 250 is an interface to receive an operation of the user. The operating unit 250 may be, for example, a button provided to the terminal device 200. Moreover, the display unit 240 and the operation unit 250 may be combined to form a touch panel.

### 2. Flow of Processing

### 2.1 Overview of Flow

FIG. 4 is a flowchart schematically showing processing to be executed by the information processing system 10 in FIG. 1.

First, the supply chain network obtaining unit 110 obtains the supply chain network 121 (Step S101). As can be seen, the supply chain network obtaining unit 110 may generate the supply chain network 121 in accordance with open information.

FIG. 5 is a graph illustrating an example of the supply chain network 121 to be obtained by the supply chain network obtaining unit 110. In FIG. 5, each of the nodes is illustrated in a circle. Moreover, in FIG. 5, the arrows connecting the nodes together represent links. FIG. 5 shows eight nodes from a company A1 to a company A8. The node of the company A1 and the node of the company A2 respectively have a link C1 and a link C2 both directed to the company A5. The node of the company A3 and the node of the company A4 respectively have a link C3 and a link C4 both directed to the company A6. The node of the company A5 and the node of the company A6 respectively have a link C5 and a link C6 both directed to the company A7. The node of the company A7 has a link C7 directed to the company A8. The arrow representing each link shows a trading relationship. For example, the link C1 shows that a product is provided from the company A1 to the company A5. That is, the link C1 shows that the company A1 is a company to provide the product and the company A5 is a company to receive the product.

The information processing system 10 obtains the supply chain network 121 at Step S101. After that, the information processing system 10 executes, with the server system 100, the first analysis processing (Step S102). The first analysis processing is analysis processing focused on the nodes of the supply chain network 121. In the first analysis processing, the server system 100 calculates a vector representation of each node in the supply chain network 121, and calculates an association degree between the nodes, using the vector representation. Details of the first analysis processing will be described later.

Moreover, the information processing system 10 executes, with the server system 100, the second analysis processing (Step S103). The second analysis processing is analysis processing focused on the links of the supply chain network 121. In the second analysis processing, the server system 100 generates the link network 122 in which each of the links in the supply chain network 121 represents a new node. Then, the server system 100 calculates a vector representation of each of the new nodes in the link network 122, and calculates an association degree between the new nodes, using the vector representation. Details of the second analysis processing will be described later.

The server system 100 may execute at least one of the first analysis processing or the second analysis processing. The information processing system 10 may execute both the first analysis processing and the second analysis processing. If the information processing system 10 executes both the first analysis processing and the second analysis processing, these processings may be executed either sequentially or simultaneously.

The information processing system 10 causes the presentation processing unit 119 to execute the first analysis processing and/or the second analysis processing, and, after that, to execute presentation processing to present the result of the processing (Step S104). Details of the presentation processing will be described later.

### 2.2 Flow of First Analysis Processing

FIG. 6 is a flowchart showing the first analysis processing to be executed by the information processing system 10 in FIG. 1.

First, the virtual node adding unit 112 adds virtual nodes to the supply chain network 121 to generate the supply chain network 121 including the virtual nodes (Step S111).

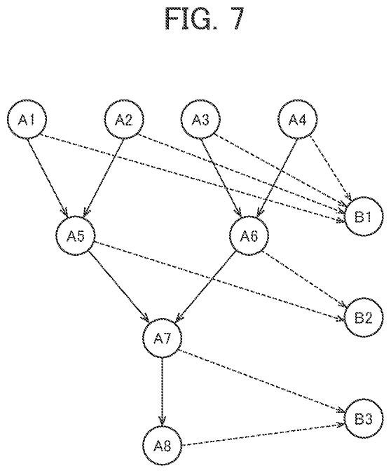

FIG. 7 is a graph illustrating an example of the supply chain network 121 including virtual nodes. The virtual node adding unit 112 at Step S111 adds a virtual node to the supply chain network 121 illustrated in, for example FIG. 5. The virtual node indicates the industrial classification of a company represented by, for example, a node included in the supply chain network 121. For example, in the supply chain network 121 in FIG. 5, the company A1, the company A2, the company A3, and the company A4 are provided with an attribute; namely, an industrial classification B1. In such a case, the virtual node adding unit 112 may add, to the supply chain network 121, a node representing the industrial classification B1. Moreover, for example, in the supply chain network 121 in FIG. 5, the company A5 and the company A5 are provided with an attribute; namely, an industrial classification B2. In such a case, the virtual node adding unit 112 may add, to the supply chain network 121, a node representing the industrial classification B1. Furthermore, for example, in the supply chain network 121 in FIG. 5, the company A7 and the company A8 are provided with an attribute; namely, an industrial classification B3. In such a case, the virtual node adding unit 112 may add, to the supply chain network 121, a node representing the industrial classification B3. The virtual node adding unit 112 may add, as the virtual nodes, only one or some of the industrial classifications of the companies represented by the nodes included in the supply chain network 121. Alternatively, the virtual node adding unit 112 may add all of the industrial classifications as the virtual nodes. For example, in the example described here, the virtual node adding unit 112 may add, as the virtual nodes, only one or some of the industrial classifications B1, B2, and B3. Alternatively, the virtual node adding unit 112 may add all of the industrial classifications B1, B2, and B3 (three industrial classifications) as the virtual nodes. Here, as illustrated in FIG. 7, all of the industrial classifications B1, B2, and B3 are added as the virtual nodes.

The virtual node adding unit 112 connects, at Step S111, a plurality of nodes and the added virtual nodes with links having directions, in accordance with the industrial classification included in an attribute provided to each of the plurality of nodes in the supply chain network 121. Specifically, the virtual node adding unit 112 connects a node provided with a given industrial classification and a virtual node representing the given industrial classification together with a link. For example, in the example of FIG. 7, the companies A1, A2, A3, and A4 are provided with an attribute; namely, the industrial classification B1. Hence, as illustrated by the arrows in broken lines in FIG. 7, the virtual node adding unit 112 connects together the nodes representing the companies A1, A2, A3, and A4 and the node representing the industrial classification B1 with links from the respective nodes representing the companies A1, A2, A3, and A4 toward the node representing the industrial classification B1. Moreover, in the example of FIG. 7, the companies A5 and A6 are provided with an attribute; namely, the industrial classification B2. Hence, as illustrated by the arrows in broken lines in FIG. 7, the virtual node adding unit 112 connects together the nodes representing the companies A5 and A6 and the node representing the industrial classification B2 with links from the respective nodes representing the companies A5 and A6 toward the node representing the industrial classification B2. Furthermore, in the example of FIG. 7, the companies A7 and A8 are provided with an attribute; namely, the industrial classification B3. Hence, as illustrated by the arrows in broken lines in FIG. 7, the virtual node adding unit 112 connects together the nodes representing the companies A7 and A8 and the node representing the industrial classification B3 with links from the respective nodes representing the companies A7 and A8 toward the node representing the industrial classification B3. Hence, the virtual node adding unit 112 generates, at Step S111, the supply chain network 121 including the virtual nodes as illustrated in FIG. 7.

Note that the first analysis processing does not necessarily involve adding a virtual node. In the case where a virtual node is not added, the processing following Step S112 is executed in accordance with the original supply chain network 121 with no virtual node added thereto. In the case where a virtual node is added, as illustrated in FIG. 7, for example, a node representing a company and a node representing an industrial classification provided to the node are connected together with a link. Hence, the calculation of a vector representation at Step S112 in the first analysis processing reflects the influence of a link connecting a node representing a company and a node representing an industrial classification provided to the node, thereby improving the precision of the vector representation.

Next, the vector representation calculating unit 113 calculates, for each of the nodes included in the supply chain network 121, a vector representation indicating a feature amount of the node, by application of a graph embedding technique to the supply chain network 121 (Step S112). Here, because the virtual node adding unit 112 generates the supply chain network 121 including virtual nodes, the vector representation calculating unit 113 applies the graph embedding technique to the supply chain network 121 including the virtual nodes.

The vector representation calculating unit 113 can use node2vec as the graph embedding technique. Specifically, the vector representation calculating unit 113 generates a cluster of sequence data formed of links through the use of random walks starting at a given node of the supply chain network 121 including the virtual nodes. For example, in the example of FIG. 7, the vector representation calculating unit 113 generates a cluster of sequence data formed of links through the use of random walks starting at anode representing the company A1. Then, the vector representation calculating unit 113 applies a technique; namely, skip-gram, to the cluster of sequence data starting at the node representing the company A1, and extracts a feature amount of the node representing the company A1. Hence, the vector representation calculating unit 113 calculates a vector representation of the node representing the company A1. Here, vi denotes a vector representation of a node representing a given company i. That is, v_{A1} denotes a vector representation of the node representing the company A1. As to the nodes representing the companies A2 to A8, the vector representation calculating unit 113 also generates clusters of sequence data and applies skip-gram to calculate vector representations _{VA2} to _{VA8}.

When the vector representation calculating unit 113 calculates the vector representations, the association degree calculating unit 114 calculates an association degree between the nodes, using the vector representations (Step S113). The association degree calculating unit 114 calculates, for example, a cosine similarity as the association degree. Specifically, a cosine similarity wᵢⱼ between the node representing the given company i and a node representing a company j is calculated with the expression (1) below.

$$[ Math . 1 ]$$

$${w}_{ij} = cos ( {v}_{i} , {v}_{j} ) = \frac{{v}_{i} \cdot {v}_{j}}{\vert {v}_{i} \vert \vert {v}_{j} \vert} \qquad ( 1 )$$

The association degree calculating unit 114 may calculate, at Step S113, cosine similarities wᵢⱼ for all the combinations of the nodes representing the companies included in the supply chain network 121.

Next, when the input receiving unit 118 receives a selection operation to select any of the plurality of companies represented by the nodes included in the supply chain network 121, the association degree calculating unit 114 calculates an association degree between the node of a company selected by the selection operation and the node of another company (Step S114). For example, if the company A1 is selected by the selection operation, the association degree calculating unit 114 calculates an association degree between the company node of the company A1 and the node of another company. Note that, here, the association degree calculating unit 114 calculates, at Step S113, cosine similarities wᵢⱼ for all the combinations of the nodes representing the companies included in the supply chain network 121. Hence, at Step S114, the association degree calculating unit 114 may execute processing to extract only the cosine similarity related to the company A1 among the cosine similarities wᵢⱼ calculated at Step S113.

Thanks to the processing at Step S114, the information processing system 10 can extract and output information on a company that the user desires.

In a flow of the first analysis processing, the information processing system 10 calculates vector representations of nodes by application of a graph embedding technique, and calculates association degrees between the nodes using the vector representations. As can be seen, the information processing system 10 can present the association degrees between the nodes in numbers. Hence, depending on how large or small the numbers are, the companies represented by the nodes can be evaluated for their association. Hence, the supply chain analysis to be executed can reflect reality more closely than a conventional supply chain analysis.

As an example, suppose a semiconductor manufacturer manufacturing semiconductors as a business purchases semiconductor manufacturing apparatuses from a manufacturing apparatus manufacturer, and foods for a company cafeteria from a food company. In such a case, the supply chain network includes nodes representing the manufacturing apparatus manufacturer and the food company and a node representing the semiconductor manufacturer connected together with links. In such a supply chain network, vector representations are calculated for the nodes of the semiconductor manufacturer, the manufacturing apparatus manufacturer, and the food company, and association degrees between the nodes are calculated. Hence, an essential link associated with the business can be determined. For example, if an association degree between the vector representation of the node representing the semiconductor manufacturer and the vector representation of the node representing the manufacturing apparatus manufacturer is a given threshold or more, the information processing system 10 can determine that the link connecting together the node representing the semiconductor manufacturer and the node representing the manufacturing apparatus manufacturer is an essential link associated with the business. Meanwhile, if an association degree between the vector representation of the node representing the semiconductor manufacturer and the vector representation of the node representing the food company is less than the given threshold, the information processing system 10 can determine that the link connecting together the node representing the semiconductor manufacturer and the node representing the food company is a non-essential link not associated with the business. Hence, the information processing system 10 can automatically determine an essential link. As a result, the supply chain analysis to be executed can reflect reality more closely.

### 2.3 Flow of Second Analysis Processing

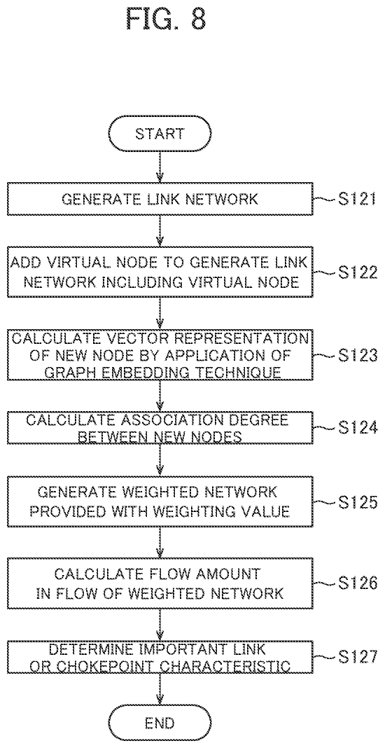

FIG. 8 is a flowchart showing the second analysis processing to be executed by the information processing system 10 in FIG. 1.

First, the network converting unit 111 converts the supply chain network 121 into the link network 122 to generate the link network 122 (Step S121).

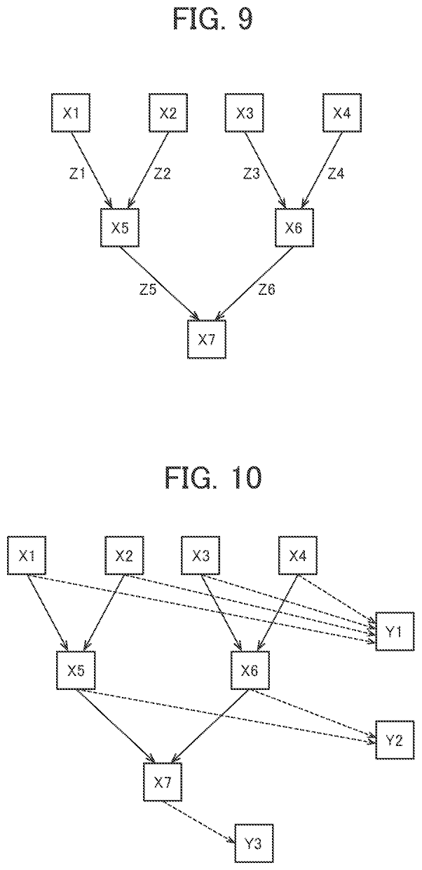

When the network converting unit 111 converts the supply chain network 121 into the link network 122, the network converting unit 111 determines the links of the supply chain network 121 as new nodes of the link network 122. FIG. 9 is a graph illustrating an example of the link network 122. Specifically, FIG. 9 is a graph illustrating the link network 122 generated by converting the supply chain network 121 in FIG. 5. In FIG. 9, the new nodes are illustrated in rectangles. Moreover, in FIG. 9, the arrows connecting the nodes together represent new links.

As illustrated in FIG. 5, the supply chain network 121 includes seven links from the link C1 to the link C7. The network converting unit 111 determines each of these seven links from C1 to C7 as a new node as illustrated in FIG. 9. In the examples in FIGS. 5 and 9, a new node X1 in FIG. 9 corresponds to a link C1 in FIG. 5. For example, a new node X1 in FIG. 9 corresponds to the link C1 in FIG. 5. Hence, the link network 122 to be generated by converting the supply chain network 121 in FIG. 5 includes seven nodes from the new node X1 to a new node X7.

The network converting unit 111 provides a new attribute to each of the new nodes in the link network 122. The new attribute can be, for example, a combination of industrial classifications of nodes connected with links in the supply chain network 121. For example, in the supply chain network 121 illustrated in FIG. 5, the link C1 connects the node of the company A1 and the node of the company A5. The company A is in the industrial classification B1, and the company A5 is in the industrial classification B2. In such a case, the network converting unit 111 provides, as a new attributes, a combination of the industrial classifications B1 and B2 to the new node X1. With a similar manner, the new nodes X2, X3, and X4 are provided with a combination of the industrial classifications B1 and B2 as a new attribute. Moreover, the new nodes X5 and X6 are provided with a combination of the industrial classifications B2 and B3. If one industrial classification is provided to nodes connected to a link in the supply chain network 121, the one industrial classification alone may be provided as a new attribute. For example, the link C7 connects the node of the company A7 and the node of the company A8 together. The companies A7 and A8 are both in the industrial classification B3. In such a case, the new node X7 is provided with the industrial classification B3.

Moreover, the network converting unit 111 connects the new nodes with new links determined in accordance with the relationships between the plurality of nodes and the plurality of links in the supply chain network 121. The network converting unit 111 connects the new nodes with new links in accordance with the relationships between the plurality of nodes and the plurality of links in the supply chain network 121. For example, in the supply chain network 121 illustrated in FIG. 5, the links C1 and C2 are links directed to the node A5, and the link C5 is a link directed from the node A5. In accordance with these relationships, the network converting unit 111 connects the new nodes X1 and X2 and the new node X5 together with new links Z1 and Z2 each directed to the new node X5 from the new nodes X1 and X2 respectively corresponding to the links C1 and C2. The new links Z1 and Z2 can be understood to correspond to the node A5 in the supply chain network 121. Likewise, the network converting unit 111 connects the new nodes X3 and X4 and the new node X6 together with new links Z3 and Z4 each directed to the new node X6 from the new nodes X3 and X4 respectively corresponding to the links C3 and C4. The new links Z3 and Z4 can be understood to correspond to the node A6 in the supply chain network 121. Likewise, the network converting unit 111 connects the new nodes X5 and X6 and the new node X7 together with new links Z5 and Z6 each directed to the new node X7 from the new nodes X5 and X6 respectively corresponding to the links C5 and C6. The new links Z5 and Z6 can be understood to correspond to the node A7 in the supply chain network 121. Hence, as illustrated in FIG. 9, the link network 122 is generated as a directed graph.

Next, the virtual node adding unit 112 adds a virtual node to the link network 122 generated at Step S121 to generate the link network 122 including the virtual node (Step S122).

FIG. 10 is a graph illustrating an example of the link network 122 including virtual nodes. The virtual node adding unit 112 adds, at Step S122, a virtual node determined in accordance with industrial classifications of companies represented by nodes included in the supply chain network 121. For example, the virtual node adding unit 112 adds a virtual node representing a combination of industrial classifications provided to a new node included in the link network 122 illustrated in FIG. 9. Specifically, as described above, the new nodes X1, X2, X3, and X4 are provided with the combination of the industrial classifications B1 and B2. In such a case, as illustrated in FIG. 10, the virtual node adding unit 112 may add, to the link network 122, a node Y1 representing the combination of the industrial classifications B1 and B2. Moreover, the new nodes X5 and X6 are provided with the combination of the industrial classifications B2 and B3. In such a case, as illustrated in FIG. 10, the virtual node adding unit 112 may add, to the link network 122, a node Y2 representing the combination of the industrial classifications B2 and B3. Furthermore, the new node X7 is provided with the industrial classification B3. In such a case, as illustrated in FIG. 10, the virtual node adding unit 112 may add, to the link network 122, a node Y3 representing the industrial classification B3. The virtual node adding unit 112 may add, as the virtual nodes, only one or some of the combinations of the industrial classifications provided to the new nodes. Alternatively, the virtual node adding unit 112 may add all of the combinations as the virtual nodes. For example, in the example described here, the virtual node adding unit 112 may add, as the virtual nodes, only one or some of the combination of the industrial classifications B1 and B2, the combination of the industrial classifications B2 and B3, and the industrial classification B3. Alternatively, the virtual node adding unit 112 may add all of the combinations and the industrial classification B3 (three industrial classifications) as the virtual nodes. Here, as illustrated in FIG. 10, all of the combination of the industrial classifications B1 and B2, the combination of the industrial classifications B2 and B3, and the industrial classification B3 are added as the virtual nodes.

The virtual node adding unit 112 at Step S122 connects together each of the plurality of new nodes and the added virtual nodes with links having directions, in accordance with information on the industrial classifications provided to each of the plurality of new nodes (i.e. a combination of industrial classifications). Specifically, the virtual node adding unit 112 connects a new node provided with a combination of given industrial classifications and a virtual node representing the combination of the given industrial classifications together with a link. For example, in the example in FIG. 10, the new nodes X1, X2, X3, and X4 are provided with the combination of the industrial classifications B1 and B2. Hence, as illustrated by the arrows in broken lines in FIG. 10, the virtual node adding unit 112 connects together the new nodes X1, X2, X3, and X4 and the node Y1 with links from the respective new nodes X1, X2, X3, and X4 toward the node Y1 representing the combination of the industrial classifications B1 and B2. Moreover, in the example in FIG. 10, the new nodes X5 and X6 are provided with the combination of the industrial classifications B2 and B3. Hence, as illustrated by the arrows in broken lines in FIG. 10, the virtual node adding unit 112 connects together the new nodes X5 and X6 and the node Y2 with links from the respective new nodes X5 and X6 toward the node Y2 representing the combination of the industrial classifications B2 and B3. Furthermore, in the example in FIG. 10, the new node X7 is provided with the industrial classification B3. Hence, as illustrated by the arrows in broken lines in FIG. 10, the virtual node adding unit 112 connects together the new node X7 and the node Y3 with a link from the new node X7 toward the node Y3 representing the industrial classification B3. Hence, at Step S1221, the virtual node adding unit 112 generates the link network 122 including the virtual nodes illustrated in FIG. 10.

Note that the second analysis processing does not necessarily involve adding a virtual node. In the case where a virtual node is not added, the processing following Step S123 is executed in accordance with the original link network 122 with no virtual node added thereto. In the case where a virtual node is added, as illustrated in FIG. 10, for example, a new node representing a link of the supply chain network 121 and a new node determined in accordance with an industrial classification are connected together with a link. Hence, the calculation of a vector representation at Step S123 in the second analysis processing reflects the influence of a new link connecting together a new node corresponding to a link of the supply chain network 121 and a new node determined in accordance with an industrial classification, thereby improving the precision of the vector representation.

Next, the vector representation calculating unit 113 calculates, for each of the new nodes included in the link network 122, a vector representation indicating a feature amount of the new node, by application of a graph embedding technique to the link network 121 (Step S123). Here, because the virtual node adding unit 112 generates the link network 122 including virtual nodes, the vector representation calculating unit 113 applies the graph embedding technique to the link network 122 including the virtual nodes.

The vector representation calculating unit 113 can use node2vec as the graph embedding technique. Specifically, the vector representation calculating unit 113 generates a cluster of sequence data formed of new links through the use of random walks starting at a given new node of the link network 121 including the virtual nodes. For example, in the example of FIG. 10, the vector representation calculating unit 113 generates a cluster of sequence data formed of new links through the use of random walks starting at the new node X1. Then, the vector representation calculating unit 113 applies a technique; namely, skip-gram, to the cluster of sequence data starting at the new node X1, and extracts a feature amount of the new node X1. Hence, the vector representation calculating unit 113 calculates a vector representation v_{X1} of the new node X1. As to the new nodes X2 to X7, the vector representation calculating unit 113 also generates clusters of sequence data and applies skip-gram to calculate vector representations v_{X2} to v_{X7}.

When the vector representation calculating unit 113 calculates the vector representations, the association calculating unit 114 calculates an association degree between the new nodes, using the vector representations (Step S124). The association calculating unit 114 calculates, for example, a cosine similarity as the association degree. The cosine similarity is calculated with the above expression (1). The association degree calculating unit 114 may calculate, at Step S124, cosine similarities wᵢⱼ for all the combinations of the new nodes included in the link network 122.

Here, as described above, a new node Xi in the link network 122 corresponds to a link Ci in the supply chain network 121. Hence, the calculation of association degrees between the new nodes in the link network 122 can be interpreted as the calculation of association degrees between the links in the supply chain network 121. The association degree calculating unit 114 may generate a distribution chart showing the association degrees between the links of the supply chain network 121, in accordance with the calculated association degrees between the new nodes. For example, the association degree calculating unit 114 may generate a distribution chart showing association degrees between links directed to a node (i.e. links to enter the node) representing a given company in the supply chain network 121 and links directed from the node to another node (i.e. links to exit from the node).

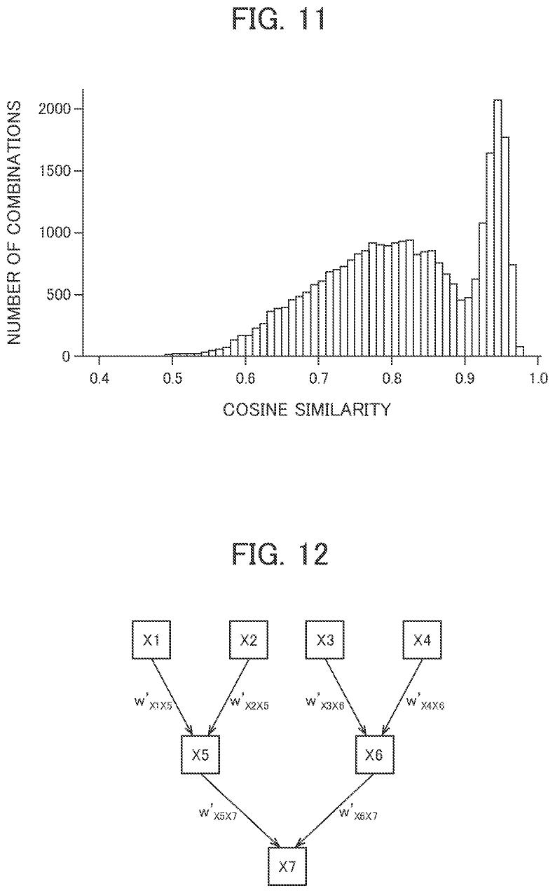

FIG. 11 is an example of a distribution chart illustrating association degrees between links to enter a node of a given company and links to exit from the node. FIG. 11 is a chart illustrating distribution of cosine similarities between links to enter a node of a given company and links to exit from the node. In the distribution chart illustrated in FIG. 11, the horizontal axis represents the values of the cosine similarities and the vertical axis represents the number of combinations of links having respective values of the cosine similarities. Note that the example of the distribution chart illustrated in FIG. 11 does not necessarily show distribution based on the link network 122 illustrated in FIG. 9.

The more similar a given new node and another new node are to each other, the closer the value of the cosine similarity is to 1. The less similar the given new node and the other new node are to each other, the closer the value of the cosine similarity is to 0. Hence, in the distribution chart illustrated in FIG. 11, the closer the cosine similarity is to 1, the more similar the link to enter and the link to exit are.

The distribution chart illustrated in FIG. 11 may be generated by, for example, the vector representation calculating unit 113. The vector representation calculating unit 113 may cause the terminal device 200 to display, for example, the generated distribution chart. The processing to display the distribution chart may be executed at Step S104 in FIG. 4. When the distribution chart is presented, the user can, for example, visually understand the distribution of the association degrees.

Next, the weighted network generating unit 115 generates the weighted network 123 in which a weighting value is provided to a new link of the link network 122 (Step S125). The weighted network generating unit 115 at Step S125, first, calculates a weighting value for each of the new links. The weighted network generating unit 115 can calculate a weighting value for each of the new links, in accordance with an association degree calculated by the association degree calculating unit 114. The weighted network generating unit 115 may, for example, determine the cosine similarity wᵢⱼ, representing an association degree, to remain as it is as a weighting value. The weighted network generating unit 115 may, for example, execute predetermined mathematical processing on the cosine similarity wᵢⱼ to calculate a weighting value.

For example, the weighted network generating unit 115 may calculate a weighting value for each of the new links directed to a given new node, so that the sum of the weighting values of the new links directed to the given new node is 1. Here, each of the weighting values of the new links may be determined in proportion to the cosine similarity wᵢⱼ. That is, the weighted network generating unit 115 may calculate the weighting values of the new links, so that the sum of the weighting values of the new links directed to the given new node is 1, and each of the weighting values of the new links is proportional to the cosine similarity wᵢⱼ. Specifically, the weighted network generating unit 115 can calculate, with an expression (2) below, a weighting value w′ᵢⱼ of a link connecting a new node i and a new node j together.

$$[ Math . 2 ]$$

$${w}_{ij}^{′} = \frac{{w}_{ij}}{{\sum }_{h} {w}_{hj}} \qquad ( 2 )$$

For example, if a ratio of a cosine similarity w_{X5X7} of the new link Z5 directed to the new node X7 to a cosine similarity w_{X6X7} of the new link Z6 directed to the new node X7 is 1:4, the weighted network generating unit 115 uses the expression (2) above to obtain 0.2 as a weighting value w′_{X5X7} of the link Z5, and 0.8 as a weighting value w′_{X6X7} of the link Z6. The weighted network generating unit 115 calculates the weighting value w′ᵢⱼ for all of the new links in the link network 122.

Note that the weighting value may be calculated not only by the calculating technique described here but also by another calculating technique. For example, here, the weighting value for each of the new links may be determined in proportion to the cosine similarity wᵢⱼ. However, the weighting value may be determined by any given technique. For example, the weighting value may be determined in proportion to the square of the cosine similarity wᵢⱼ. The weighting value may be calculated by any other appropriate technique based on the association degree.

The weighted network generating unit 115 provides the calculated weighting value to each of the new links to generate the weighted network 123. FIG. 12 is a graph illustrating an example of a weighted network. As illustrated in FIG. 12, in the weighted network 123, each of the new links in the link network 122 is provided with the calculated weighting value w′ᵢⱼ.

Then, the flow amount calculating unit 116 calculates a flow amount in a flow of the weighted network 123 (Step S126). The flow amount calculating unit 116 calculates a flow amount, using weighting values of the weighted network 123. The flow amount calculating unit 116 may calculate a flow amount, using a predetermined any given arithmetic expression. For example, a flow amount may be calculated as a product of the weighting values provided to the new links in a flow. Here, in this Specification, the flow amount of a flow from any given one new node N1 to another new node N2 is referred to as a “flow amount of the new node N1 with respect to the new node N2”.

For example, if the flow amount of a flow from the new node X5 to the new node X7 is calculated, that is, if a flow amount of the new node X5 with respect to the new node X7 is calculated, the flow amount calculating unit 116 calculates a product of the weighting values provided to the new link in the flow from the new node X5 to the new node X7. Here, the weighting values may be calculated where a flow amount of the new node X7 positioned most downstream of the flow is 1. The new link Z5 is the only link of the flow from the new node X5 to the new node X7. Hence, the flow amount of the new node X5 with respect to the new node X7 is a weighting value w′_{X5X7} provided to the link Z5. This flow amount is a value to represent an index showing the trading relationship of the new node X5 with respect to the new node X7.

For example, if a flow amount of the new node X1 with respect to the new node X7 is calculated, the flow amount calculating unit 116 calculates a product of the weighting values provided to the new links in the flow from the new node X1 to the new node X7. As can be understood from FIG. 9, the new links Z1 and Z5 are the links in the flow from the new node X1 to the new node X7. In such a case, the flow amount of the flow from the new node X1 to the new node X7 is a product of a weighting value w′_{X1X5} provided to the link Z1 and a weighting value w′_{X5X7} provided to the link Z5. That is, the flow amount of the new node X1 with respect to the new node X7 is represented as w′_{X1X5}×w′_{X5X7}. This flow amount is a value to represent an index showing the trading relationship of the new node X1 with respect to the new node X7.

For example, if a flow amount of the new node X2 with respect to the new node X7 is calculated, the flow amount calculating unit 116 calculates a product of the weighting values provided to the new links in the flow from the new node X2 to the new node X7. As can be understood from FIG. 9, the new links Z2 and Z5 are the links in the flow from the new node X2 to the new node X7. In such a case, the flow amount of the flow from the new node X2 to the new node X7 is a product of a weighting value w′_{X2X5} provided to the link Z2 and a weighting value w′_{X5X7} provided to the link Z5. That is, the flow amount of the new node X2 with respect to the new node X7 is represented as w′_{X2X5}×w′_{X5X7}. This flow amount is a value to represent an index showing the trading relationship of the new node X2 with respect to the new node X7.

Note that a flow amount of the new node N1 with respect to the new node N2 is a sum of the flow amounts, of the new nodes connected to the new node N1 with the new links directed to the new node N1, with respect to the new node N2. For example, in the example illustrated in FIG. 12, the new node X5 is connected to each of the new nodes X1 and X2 with the new links Z1 and Z2. In such a case, the flow amount w′_{X5X7} of the new node X5 with respect to the new node X7 is a sum of the flow amount W′_{X1X5}×w′_{X5X7} of the new node X1 with respect to the new node X7 and the flow amount w′_{X2X5}×w′_{X5X7} of the new node X2 with respect to the new node X7.

Moreover, if there are a plurality of flows from the new node N1 to the new node N2, the flow amount of the new node N1 with respect to the new node N2 is a sum of flow amounts of the plurality of flows. For example, if the flow from the new node N1 to the new node N2 includes two flows such as a first flow and a second flow, a sum of a flow amount of the first flow and a flow amount of the second flow is the flow amount of the new node N1 with respect to the new node N2.

The flow amount calculating unit 116 may calculate the flow amounts of all the flows to be obtained in the weighted network 123. Moreover, the flow amount calculating unit 116 may calculate the flow amount of a flow of a specific new node in the weighted network 123. For example, the flow amount calculating unit 116 may calculate the flow amounts of all the flows for the new node X7. For example, in the example illustrated in FIG. 9, the flow for the new node X7 includes six flows in total starting at the respective new nodes X1, X2, X3, X4, X5, and X6 and ending at the new node X7.

The determining unit 117 determines an important link or a chokepoint characteristic in accordance with the flow amounts calculated by the flow amount calculating unit 116 at Step S126 (Step S127). For example, the determining unit 117 determines an important link in the supply chain network 121 or the link network 122. Among the flow amounts calculated by the flow amount calculation units 116, the determining unit 117 may determine that an important link is a link positioned in a flow whose flow amount has a predetermined threshold or more. For example, suppose the flow amount of the flow from the new node X1 to the new node X7 has a predetermined threshold or more. In such a case, the determining unit 117 may determine that the links Z1 and Z5 positioned in this flow are important links. Here, the links Z1 and Z5 correspond to respective nodes representing the companies A5 and A7 in the supply chain network 121. Hence, the determining unit 117 may determine that the nodes representing the companies A5 and A7 are important nodes. Moreover, the determining unit 117 may determine that the new nodes X1, X5, and X7 positioned in this flow are important nodes. In such a case, the new nodes X1, X5, and X7 respectively correspond to the links C1, C5, and C7 in the supply chain network 121. Hence, the determining unit 117 may determine that the links C1, C5, and C7 are important links. The determining unit 117 may determine that a link or a node determined as an important link or an important node is high in chokepoint characteristic.

The determining unit 117 may, for example, execute a predetermined computation using a flow amount, and determine an important link or a chokepoint characteristic using the result of the computation. That is, the determining unit 117 may use the result of the computation as a determining index for determining an important link or a chokepoint characteristic. For example, the determining unit 117 may calculate a sum of flow amounts of flows starting at a given first new node and ending at a given second new node. The determining unit 117 determines that the sum of the flow amounts as the calculation result is the determining index for the given first new node and the given second new node. The determining unit 117 may calculate a sum of flow amounts also for another flow. The determining unit 117 may, for example, compare the calculated determining indexes, and, in accordance with how large or small the determining indexes are, determine an important link or a chokepoint characteristic. For example, the determining unit 117 may determine that links, which are included in flows of which a sum of flow amounts is more than a predetermined threshold, are important links, and that the flows are high in chokepoint characteristic.

The determining unit 117 may calculate, for each of the companies, a determining index for determining an important node in the supply chain network 121, in accordance with flow amounts of new nodes in the link network 122. The determining unit 117 may determine an important node in accordance with determining indexes. For example, in the supply chain network 121 in FIG. 5, the links C1 and C2 are the links directed to the node representing the company A5. In the link network 122 in FIG. 9, the new nodes X1 and X2 respectively correspond to the links C1 and C2. The determining unit 117 may calculate a sum of the flow amounts of the new nodes X1 and X2, and determine the sum as the determining index of the company A5. If the value of the determining index is a predetermined threshold or more, the determining unit 117 may determine that the node representing the company A5 in the original supply chain network 121 is an important node.

The determining unit 117 may rank determining indexes of the companies for each of the path lengths of the flows in the link network 122. The path length of a flow is the number of the links included in the flow. For example, in the example of FIG. 9, the path length is 1 for the flow from the new node X1 to the new node X5 because this flow includes the new link Z1. Likewise, the path length is also 1 for, for example, the flow from the new node X2 to the new node X5 and the flow from the new node X5 to the new node X7. For example, the path length is 2 for the flow from the new node X1 to the new node X7 because this flow includes the new links Z1 and Z5. If a plurality of flows are found from a specific node to another node, the determining unit 117 may determine that the shortest path length among the path lengths of the plurality of flows is the path length of the flow from the specific node to the other node.

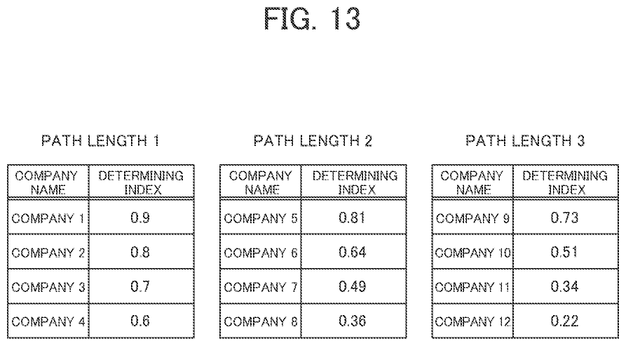

FIG. 13 shows tables citing an example of results ranking determining indexes for each of the path lengths. As cited as an example in FIG. 13, the determining unit 117 may rank determining indexes of the companies for each of the path lengths. Note that the example of the ranking cited in FIG. 13 does not necessarily show ranking based on the supply chain network 121 illustrated in FIG. 5 and the link network 122 illustrated in FIG. 9. The example cited in FIG. 13 is a result of ranking for: a path length 1 showing that the path length is 1 (i.e. the number of links included in the flow is 1); a path length 2 showing that the path length is 2; and a path length 3 showing that the path length is 3. In FIG. 13, the columns “COMPANY NAME” include such information as a company name that uniquely identifies a company. The columns “DETERMINING INDEX” include figures indicating determining indexes. With reference to FIG. 13, in the case of the path length 1, the company name “COMPANY 1” has the highest determining index of 0.9, and the company name “COMPANY 2” has the second highest determining index of 0.8. In the case of the path length 2, the company name “COMPANY 5” has the highest determining index of 0.81, and the company name “COMPANY 6” has the second highest determining index of 0.64. As can be seen, the determining unit 117 may rank determining indexes for each of the path lengths. The determining unit 117 may determine an important node in accordance with a result of the ranking. For example, the determining unit 117 may determine for each of the path lengths that higher ranking companies having higher determining indexes are important nodes.

According to the second analysis processing flow, the information processing system 10 converts the supply chain network 121 into the link network 122, generates the weighted network 123 from the link network 122 provided with weighting values, and calculates the flow amount of a flow in the weighted network 123. Because the new nodes in the link network 122 represent trading relationships between companies, the analysis to be executed in the second analysis processing can focus on the new nodes representing the trading relationships. Then, in the second analysis processing, the flow amount calculating unit 116 calculates a flow amount in a flow in the weighted network 123. This flow amount is calculated in accordance with a weighting value to be calculated in accordance with an association degree of new nodes representing a trading relationship. Thus, the flow amount reflects the association as to the trading relationship. Hence, by calculating the flow amount, the association of the trading relationship between companies can be numerically evaluated. Hence, the supply chain analysis to be executed can reflect reality more closely than a conventional supply chain analysis.

The second analysis processing is described in accordance again with the example of the semiconductor manufacturer, the manufacturing apparatus manufacture, and the food company cited in the first analysis processing. In the second analysis processing, the nodes representing the manufacturing apparatus manufacturer and the food company are each connected to the node representing the semiconductor manufacture with the links. In the second analysis processing, a link network is generated to include these links as new nodes, and the flow amount of a flow in the link network is calculated. For example, if the flow amount of a flow, in which the link connecting together the node representing the manufacturing apparatus manufacturer and the node representing the semiconductor manufacturer is a new node, is a predetermined threshold or more, the information processing system 10 can determine that the link connecting together the node representing the semiconductor manufacturer and the node representing the manufacturing apparatus manufacturer is an essential link associated with the business. Meanwhile, if the flow amount of a flow, in which the link connecting together the node representing the semiconductor manufacturer and the node representing the food company is a new node, is less than the predetermined threshold, the information processing system 10 can determine that the link connecting together the node representing the semiconductor manufacturer and the node representing the food company is a non-essential link not associated with the business. Hence, the information processing system 10 can automatically determine an essential link. As a result, the supply chain analysis to be executed can reflect reality more closely.

### 2.4 Presentation Processing

The presentation processing unit 119 executes the first analysis processing and/or the second analysis processing, and, after that, executes presentation processing to present a result of the processing to the user. The presentation processing unit 119 can present various kinds of information on the processing process or the processing result of the first analysis processing and/or the second analysis processing. For example, the presentation processing unit 119 may present the supply chain network 121 illustrated in FIG. 5, the link network 122 illustrated in FIG. 9, and the weighted network 123 illustrated in FIG. 12. The presentation processing unit 119 may present a distribution chart showing an association degree between a node of a selected company and a node of another company, as illustrated in FIG. 8. The presentation processing unit 119 may present results ranking flow amounts for each of the path lengths, as cited in FIG. 13. Moreover, the presentation processing unit 119 may extract and present information on a company selected by the selection operation. For example, the presentation processing unit 119 may extract and present a flow related to a company selected from a network by the selection operation. The presentation processing unit 119 may present a flow amount of, and a determination index for, a flow between a company selected by the selection operation and another company. When the presentation processing unit 119 executes the presentation processing, the user using the information processing system 10 can be informed of the result of processing on the information processing system 10.

The information processing system 10 may execute at least one of the first analysis processing or the second analysis processing. Note that the first analysis processing is processing analysis focusing on the nodes of the supply chain network 121, and the second analysis processing is processing analysis focusing on the links of the supply chain network 121. Thus, the first analysis processing and the second analysis processing involve analyzing a supply chain from different viewpoints. Hence, the information processing system 10 executes both the first analysis processing and the second analysis processing, making it possible to obtain an analysis result from multiple viewpoints.

### 3. Modification

In the above embodiment, at Step S122 of the second analysis processing, the virtual node adding unit 112 adds a virtual node to the link network 122 to generate the link network 122 including the virtual node. However, in the second analysis processing, the virtual node adding unit 112 does not necessarily have to add a virtual node to the link network 122. For example, in the second analysis processing, before generating the link network 122 at Step S121, the virtual node adding unit 112 may add a virtual node to the supply chain network 121 to generate the supply chain network 121 including the virtual node.

In such a case, the virtual node adding unit 112 may execute processing similar to the processing at Step S111 of the first analysis processing, prior to Step S121 of the second analysis processing. That is, the virtual node adding unit 112 may add one or more virtual nodes to the supply chain network 121. The one or more virtual nodes indicate the industrial classifications of the companies represented by the nodes included in the supply chain network 121. The virtual node adding unit 112 connects together a plurality of nodes and the added virtual nodes with links having directions, in accordance with the industrial classification included in an attribute assigned to each of the plurality of nodes in the supply chain network 121.

Hence, in the second analysis processing, when the virtual node adding unit 112 adds a virtual node to the supply chain network 121, the network converting unit 111 may, at Step S121, convert the supply chain network 121 including the virtual node into the link network 122. Here, in the second analysis processing, Step S122 may be or may not be executed. If Step S122 is executed, the virtual node adding unit 112 adds a virtual node to the link network 122, generated by the network converting unit 111, to generate the link network 122 including the virtual node. If Step S122 is not executed, the vector representation calculating unit 113 calculates a vector representation of a new node in the link network 122 generated by the network converting unit 111.

The present embodiment has been discussed so far in detail. A person skilled in the art will readily appreciate that many modifications are possible without substantially departing from the new matter and effects of the present embodiment. Accordingly, all such modifications are included in the scope of the present disclosure. For example, terms that appear at least once in the description or drawings along with another broader or synonymous term can be replaced with other terms in any part of the description or drawings. Moreover, all the combinations of the present embodiment and the modifications are encompassed in the scope of the present disclosure. Furthermore, the configurations and operations of the information processing system, the server system, and the terminal device, among others, are not limited to those described in the present embodiment, and various modifications are possible.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An information processing system, comprising:
a supply chain network obtaining unit configured to obtain a supply chain network in which a plurality of nodes are connected together with a plurality of links, the plurality of nodes corresponding to a plurality of companies and provided with attributes, the attributes including industrial classifications of the companies and related to the companies, and the plurality of links representing trading relationships associating a company to provide a product and a company to receive the product; and
a vector representation calculating unit configured to calculate a plurality of vector representations each corresponding to one of the plurality of nodes, and each representing a feature amount of one of the plurality of nodes, by application of a graph embedding technique to the supply chain network.

2. The information processing system according to claim 1, further comprising
an association degree calculating unit configured to calculate an associating degree between the plurality of nodes each corresponding to one of the plurality of vector representations, using the plurality of vector representations.

3. The information processing system according to claim 1, further comprising
a virtual node adding unit configured to: add one or more virtual nodes to the supply chain network, the one or more virtual nodes representing the industrial classifications of the companies represented by the nodes included in the supply chain network; connect together, with the links, each of the plurality of nodes and the one or more virtual nodes added, in accordance with the industrial classifications included in the attributes each provided to a corresponding one of the plurality of nodes; and generate the supply chain network including the one or more virtual nodes,
wherein the vector representation calculating unit calculates the plurality of vector representations by application of the graph embedding technique to the supply chain network including the one or more virtual nodes.

4. The information processing system according to claim 2, further comprising
an input receiving unit configured to receive a selection operation to select any of the plurality of companies represented by the nodes included in the supply chain network,
wherein the association calculating unit calculates an association degree between a node of a company selected by the selection operation and a node of an other company, using a vector representation associated with the node of the company selected by the selection operation and a vector representation associated with the node of the other company.

5. A method for processing information executed by an information processing system, the method for the processing comprising:
obtaining a supply chain network in which a plurality of nodes are connected together with a plurality of links, the plurality of nodes corresponding to a plurality of companies and provided with attributes, the attributes including industrial classifications of the companies and related to the companies, and the plurality of links representing trading relationships associating a company to provide a product and a company to receive the product; and
calculating a plurality of vector representations each corresponding to one of the plurality of nodes, and each representing a feature amount of one of the plurality of nodes, by application of a graph embedding technique to the supply chain network.

6. Anon-transitory computer-readable recording medium containing a program for causing a processor to implement processing, the processing comprising:
obtaining a supply chain network in which a plurality of nodes are connected together with a plurality of links, the plurality of nodes corresponding to a plurality of companies and provided with attributes, the attributes including industrial classifications of the companies and related to the companies, and the plurality of links representing trading relationships associating a company to provide a product and a company to receive the product; and
calculating a plurality of vector representations each corresponding to one of the plurality of nodes, and each representing a feature amount of one of the plurality of nodes, by application of a graph embedding technique to the supply chain network.
